(19) United States
(12) Patent Application Publication
(10) Pub. No.: US 2015/0024368 A1
(43) Pub. Date: Jan. 22, 2015

(54) SYSTEMS AND METHODS FOR VIRTUAL ENVIRONMENT CONFLICT NULLIFICATION

(71) Applicant: INTELLIGENT DECISIONS, INC., Ashburn, VA (US)

(72) Inventor: Everett Gordon King, JR., Huntsville, AL (US)

(21) Appl. No.: 14/333,660

(22) Filed: Jul. 17, 2014

Related U.S. Application Data
(60) Provisional application No. 61/847,715, filed on Jul. 18, 2013.

(51) Int. Cl. G09B 5/02

(52) U.S. Cl. CPC G09B 5/02
USPC 434/365

(57) ABSTRACT

The invention generally relates to virtual environments and systems and methods for avoiding collisions or other conflicts. The invention provides systems and methods for collision avoidance while exposing a participant to a virtual environment by detecting a probable collision and making a shift in the virtual environment to cause the participant to adjust their motion and avoid collision. In certain aspects, the invention provides a collision avoidance method that includes exposing a participant to a virtual environment, detecting a motion of the participant associated with a probable collision, and determining a change to the motion that would nullify the probable collision. An apparent position of an element of the virtual environment is shifted according to the determined change, thereby causing the participant to adjust the motion and nullify the probable collision.

### CROSS-REFERENCE TO RELATED APPLICATION

This application claims priority to and the benefit of U.S. Provisional Patent Application Ser. No. 61/847,715, filed Jul. 18, 2013, the contents of which are incorporated by reference.

### FIELD OF THE INVENTION

The invention generally relates to virtual environments and systems and methods for avoiding collisions or other physical conflicts.

### BACKGROUND

Virtual environments are a potentially powerful tool for training personnel to operate in complex situations that would be difficult or dangerous to duplicate in the real world. Exposing people to a virtual environment using software and hardware portraying a synthetic scene or geographic area, operating with a virtual display device such as a head-mounted display unit, creates the perception that elements within the virtual environment are real. In training, emergency responders, law enforcement officers, and soldiers can experience simulated hazardous environments and practice maneuvers that can be used the real world to save lives and maintain national security.

One great strength of virtual environments is that they need not correspond with a real physical world. For example, a few people using immersive displays and physically standing in a small area the size of a common garage can experience a virtual space of any arbitrary size. Firefighters wearing head-mounted display devices can navigate through every room on every floor of a large office tower within a virtual environment while those people are, in fact, standing within a few feet of one another in the real world. Virtual environments can model complex scenes with a great deal of spatial detail and can also enable collaboration in diverse situations. For example, security personnel could train to respond to an airplane hijacking in a virtual environment that includes people on the plane as it flies through the air while other people coordinate a ground response.

Unfortunately, trying to work within a virtual environment while using a constrained real world space leads to space management problems. For example, two firefighters that are working different floors of a firefight within a virtual environment may actually be in the same real world room together and may bump into one another as they train or virtually interact. It's not just a physical conflict with another physical person in the virtual environment that must be mitigated, but also potential spatial conflicts with props or other room structures. For example, if a physical rock outcropping is being modeled and introduced into the physical room as well as the correlated virtual scene, much like the situation of persons on different floors there may be a situation where one physical person “sees” the outcropping in their representation of the virtual environment, but another may not “see” that physical object in their representation. Thus there is a chance that an individual could run into a moveable prop (the outcropping, in this example) in this manner. Similarly, a fixed room structure such as a pole or support must be avoided by the physical participants operating in a virtual environment.

One prior art approach to keeping physical human and objects from physical conflict in a virtual environment (colliding with each other) has been to correlate the virtual scene to the real world scene so that the human immersive scene participant is actively responsible to keep separation. This approach limits the virtual world space to that of the real world space. Other prior art relates to using augmented information in the virtual scene to warn of potential spatial conflicts. For example, a visual overlay of a large exclamation mark is presented visually to a participation, or other visual marker oriented in the direction of the conflict. This is, however, not desirable as it introduces unrealistic elements into the immersive scene and requires the participant to stop with tasks, respond to the conflict, then reengage tasks which breaks immersion and concentration.

### SUMMARY

The invention provides for systems and methods to mitigate or remove spatial conflicts and collision chances for a physical human participant operating in a virtual environment. By detecting a potential collision and making an appropriate spatial shift in the virtual environment, participants will be guided to implicitly adjust their motion and avoid collision all unknown to the participant. The invention exploits the insight that moving a visible element (by rotating the viewing frustum, for example) within a virtual environment and leading a participant to adjust their own motion need not interfere with the virtual participant's psychological immersion in the scene. The participant can be redirected through changes that are effectively small incremental shifts within the virtual display, without the introduction of extrinsic instructions such as warning symbols or other visual or auditory directives that break continuity with the scene. Thus when a person is walking directly towards a physical object such as another person, a prop, or a wall or other room structure, the person can be “nudged” to walk along a curved line and they will experience a continual and uninterrupted walk without having a collision. This nudging, referred to in this invention as virtual nulling, works since the display is updated at a very high rate compared to human perception of visual information. For example, the system can virtually null the participant with a slight spatial cue change up to 60 times per second in high frame rate head mounted displays. Using subtle virtual visual cues overrides the kinesthetic perception such that walking along a curve while seeing an environment is perceived by the participant as if they are walking in a straight line. Since collisions are avoided without breaking a person's immersion in a scene, a virtual environment can be used to depict scenes that are arbitrarily larger than the actual physical space that the participants are working within. Since the mental immersion is not broken, a person's experience of the scene is engaging and effective. Thus, people can be extensively trained using expansive virtual environments in smaller physical areas without the disruptions and hazards of spatial conflicts or collisions with other physical participants or objects.

In certain aspects, the invention provides a collision avoidance method that includes exposing a physical participant to a virtual environment, detecting a motion of the participant associated with a probable collision, and determining a change to the motion that would nullify the potential collision. An apparent position of registered spatial elements of the virtual environment is shifted according to the determined change, thereby causing the participant to implicitly adjust the motion and nullify the probable collision. Exposing the physical participant to the virtual environment is achieved through a virtual display device such as a head-mounted display being worn by the participant. To implement this invention, virtual environment software preferably tracks where physical participants and any potential physical objects such as props or building structures are located in the real world. This spatial information is obtained in any suitable way such as through the use of one or more of a sensor, a camera, other input, or a combination thereof. One such method is to use three degree of freedom and six degree of freedom sensors physically affixed to physical participants and objects. These types of sensor devices use a combination of magnetometers and accelerometers to sense the position and location of the sensor in physical space. In this manner, the integrated system containing the invention can detect where real world objects are located and oriented in real time. Another approach to real time spatial assessment includes the use of a passive camera system which surveys the entire physical scene in real time, and detects the physical participants and objects as they move within the physical environment.

With the physical objects and participants location, orientation, and movement vectors known, the integrated system implementing virtual nulling can extrapolate the projected motion of the physical participant along with any projected motion (or static location) of any physical objects or structures, and then determine that the projected motion of the participant and the projected motion of other participants or objects come within a certain distance of one another, indicating the potential collision. The computer system can then associate the potential collision volume with the location and the motion of a given participant. Operating within constraints for physical human motion and equilibrium, the system can now determine a revised motion of the participant motion that would nullify the probable condition. This desired physical transformation—via virtual nulling—is preferably achieved by slowly modifying the virtual environment relative location vectors and Euler angles from participant to environment over a large number of visual display updates (say, a few seconds at 60 updates per second equates to a few hundred display updates).

The virtual environment may be used as a tool for training (e.g., for training personnel such as emergency responders, police, or military). In certain embodiments, systems or methods of the invention are used for training uniformed personnel by presenting a hazardous environment. Uniformed personnel may be defined as police officers, fire-fighters, or soldiers. A hazardous environment may be defined as an environment that, in a non-virtual setting, would pose a substantial threat to human life. A hazardous environment may similar be defined to include environments that include a raging fire, one or more firearms being discharged, or a natural disaster such as an avalanche, hurricane, tsunami, or similar. Probable collisions can involve two or more participants who are approaching one another, and can be avoided. Each of the participants may be depicted within the virtual environment, and a real-world distance between each participant can be less than an apparent distance between the participants within the virtual environment. While it will be appreciated that any participant may be a human, any participant could also be, for example, a vehicle (e.g., with a person inside), a robot, an unmanned vehicle, or an autonomous vehicle.

In other aspects, the invention provides a collision-avoidance method that involves presenting a virtual environment to a participant (person), detecting a convergence between the person and a physical object, determining a change in motion of the person that would void the convergence, and changing the virtual environment to encourage the person to make the change in motion (e.g., by shifting an apparent position of an element within the virtual environment in a direction away from the physical object).

In related aspects, the invention provides a collision avoidance method in which a participant is exposed to a virtual environment by providing data for use by a virtual display device. The method includes detecting with a sensor a motion of the participant associated with a probable collision, determining—using a computer system in communication with the sensor—a change to the motion that would nullify the probable collision, and providing updated data for the virtual display device for shifting an apparent position of an element of the virtual environment according to the determined change, thereby causing the participant to adjust the motion and nullify the probable collision.

Aspects of the invention provide a collision-avoidance method that include using a display device to present a virtual environment to a person and using a computing system comprising a processor coupled to a memory and a sensor capable of sending signals to the computing system to detect a convergence between the person and a physical object. The computer system determines a change in motion of the person that would void the convergence; and the display device changes the virtual environment to encourage the person to make the change in motion. The sensor can include a device worn by the person such as, for example, a GPS device, an accelerometer, a magnetometer, a light, others, or a combination thereof. A second sensor can be used on the physical object.

The convergence can be detected by measuring a first motion of the person and a second motion of the physical object and modeling a first projected motion of the person and a second projected motion of the physical object and determining that the person and the object are getting closer together.

The virtual environment can be changed by modeling the motion of the person as a vector within a real space coordinate system, determining a transformation of the vector that would void the convergence, and performing the transformation on a location of a landmark within the virtual environment.

Methods of the invention can include using the virtual environment for training recruits in a corps, such as police officers or military enlistees.

While the virtual display device may be a head-mounted display, it may optionally be part of a vehicle that the person is controlling that is controlled in physical space and integrated into virtual space. For example, a virtual training system with a participant wearing an HMD while operating a “Segway” scooter could implement this invention to mitigate collisions and spatial conflict.

In certain aspects, the invention provides a virtual environment system with collision avoidance. The system includes a virtual display device operable to expose a participant (e.g., human or machine) to a virtual environment, a sensor operable to detect a motion of the participant, and a computer system comprising a processor coupled to a tangible, non-transitory memory. The system is operable to communicate with the sensor and the display device, associate the motion with a probable collision, determine a change to the motion that would nullify the probable collision, and provide updated data for the virtual display device for shifting an apparent position of an element of the virtual environment according to the determined change, thereby causing the participant to adjust the motion and nullify the probable collision. In some embodiments, the virtual display device is a head-mounted display unit. The system may include a second sensor on an item that is associated with the probable collision.

In certain embodiments, the system is operable to measure a location and the motion of the participant, determine a location and motion of an item also associated with the probable collision, and model a projected motion of the participant and a projected motion of the item and determine that the projected motion of the participant and the projected motion of the item come within a certain distance of one another, indicating the probable collision.

The system may be used to model the motion of the participant as a participant vector within a real space coordinate system, model a location and motion of an item also associated with the probable collision as an item vector within the real space coordinate system, describe the apparent position of the element of the virtual environment as an element vector within a virtual coordinate system, determine a transformation of the participant vector that would nullify the probable condition, and perform the transformation on the element vector within the virtual coordinate system.

The virtual environment may be used to depict training scenarios such as emergencies within dangerous environments for training personnel. The system can depict the participant and the second participant within the virtual environment. A distance between the participant and the second participant may be less than an apparent distance between the participant and the second participant within the virtual environment.

In other aspects, the invention provides a virtual reality system with collision prevention capabilities. The system uses a display device operable to present a virtual environment to a person, a computing device comprising a processor coupled to a memory and capable of communicating with the display device, and a sensor capable of sending signals to the computing system. The system detects a convergence between the person and a physical object, determines a change in motion of the person that would void the convergence, and changes the virtual environment to encourage the person to make the change in motion.

The sensor may be worn by the person. The system may include a second sensor on the physical object (e.g., a person, prop or real-world structure).

In some embodiments, the system will measure a first motion of the person and a second motion of the physical object, model a first projected motion of the person and a second projected motion of the physical object, and determine that the person and the object are getting closer together.

Additionally or alternatively, the system may model the motion of the person as a vector within a real space coordinate system, determine a transformation of the vector that would void the convergence, and perform the transformation on a location of a landmark within the virtual environment.

The system may be used to depict training scenarios such as armed conflicts or emergencies.

### BRIEF DESCRIPTION OF THE DRAWINGS

FIG. 1 depicts a physical environment.

FIG. 2 depicts a virtual environment corresponding to person C in FIG. 1.

FIG. 3 shows persons A, B, and C having certain real world physical locations.

FIG. 4 depicts the persons in FIG. 3 having different locations as persons A′, B′, and C′ within a virtual world.

FIG. 5 illustrates the real-world set-up of people on a floor.

FIG. 6 depicts the scene that the participants shown in FIG. 5 experience from their virtual perspective.

FIG. 7 depicts a view as rendered by a system and seen by a person C.

FIG. 8 gives a plan view of the locations of persons A and B around C in FIG. 7.

FIG. 9 represents a virtual scene overlaid on a real scene.

FIG. 10 illustrates virtual nulling for collision avoidance.

FIG. 11 further illustrates the nulling of FIG. 10.

FIG. 12 shows avoiding collision with a prop.

FIG. 13 includes a structural element 115 in a collision avoidance.

FIG. 14 diagrams methods of the invention.

FIG. 15 presents a system for implementing methods of the invention.

### DETAILED DESCRIPTION

The invention provides systems and methods to mitigate physical conflicts (e.g., bumping into people and other transient or stationary physical objects) while operating in virtual environments or other immersive devices. The concept may include giving subtle “correction” queues within a virtual scene. Use of systems and methods of the invention allow for uncoupling of a physical environment from a virtual environment allowing multiple participants to operate together in a physical environment uncorrelated to the virtual environments being represented to each participant.

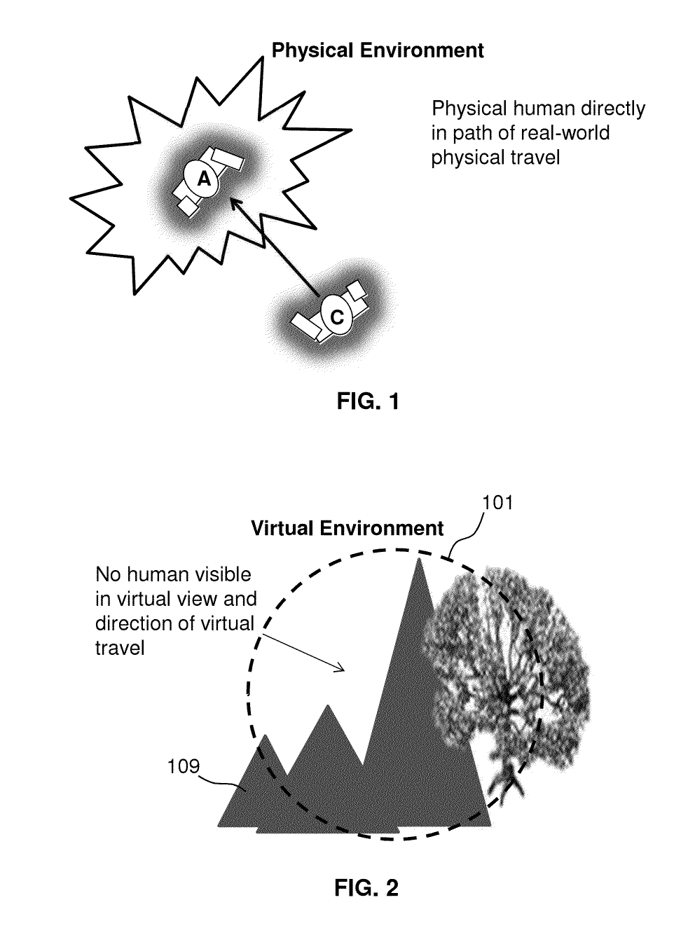

FIG. 1 depicts a physical environment. FIG. 2 depicts a virtual environment corresponding to person C in FIG. 1. In FIG. 1, person C is depicted as moving towards person A. A human participant in physical space in diagrams is represented with a shadowed outline while the participant's location in virtual space is illustrated as a human figure without a shadowed outline.

FIG. 2 represents the virtual environment that person C is experiencing. The virtual environment 101 includes one or more landmarks such as the mountain 109. It will be appreciated that person seeing the immersive virtual environment C sees landmark 109 in virtual environment but may not see person A, even though person A is actually physically in front of person C. For example, person C may be wearing a head mounted display device that presents virtual environment 101 to person C. Any suitable individually-focused, immersive virtual display device may be used to present virtual environment. In some embodiments, the device is a head mounted display such as the display device sold under the trademark ZSIGHT by Sensics, Inc. (Columbia, Md.). A display device can present an immersive virtual environment 101.

In immersive virtual environments, either used for training or task rehearsal for multiple participants, operating in a confined physical room or environment can lead to the potential of a physical space conflict. That is, the human participants may bump into each other, or other moveable or stationary elements of the room or task environment. In an immersive device, participants are presented a fully virtual rendered scene that may or may not be correlated to the physical aspects of the actual room or facility being utilized. Furthermore, the uniqueness of the virtual environment means that human participants (and physical obstacles in the room) are likely not oriented in virtual space with any amount of correlation to the physical space. A good example of this is participants standing within feet of each other in the physical room, but actually on totally different floors of a virtual building in pursuit of their tasks.

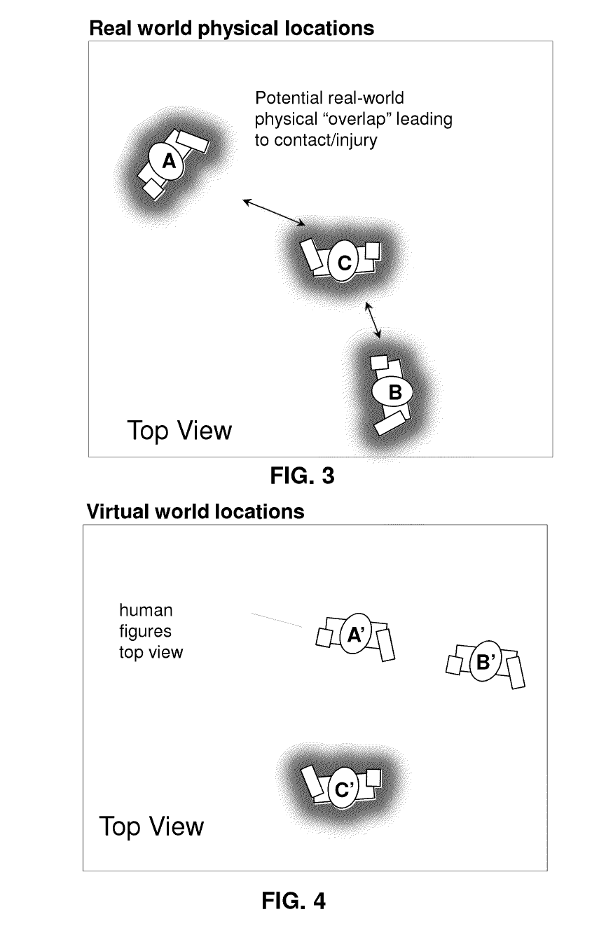

FIG. 3 shows a scenario in which persons A, B, and C have certain real world physical locations while FIG. 4 depicts those persons having different locations as persons A′, B′, and C′ within a virtual world. As a visual queue used throughout the figures, a real world person is shown with a shadow in the figures. As shown in FIG. 3, person C (represented as C′ in the virtual world in FIG. 4) may see person A′ and possibly also B′ in the periphery even though person A is not in front of person C. In fact, the virtual world people need not be in the same room or on the same floor of a building.

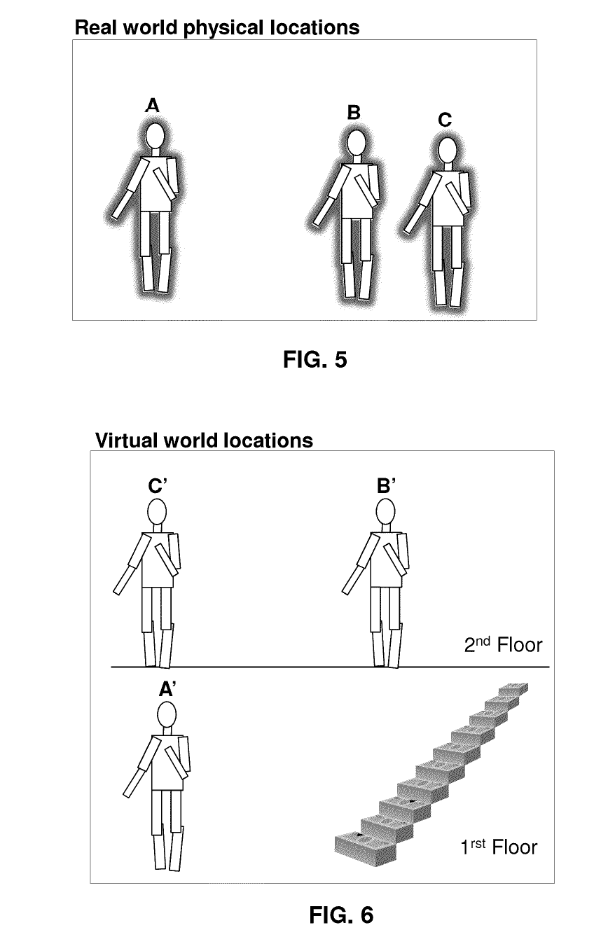

FIG. 5 illustrates the real-world set-up of people on a floor, who may be experiencing different floors of a virtual building. That is, FIG. 5 may depict an actual working virtual reality studio in which participants are trained. A virtual reality studio may also be used for entertainment. For example, a virtual environment may be provided by a video game system and FIG. 5 may be a living room.

FIG. 6 depicts the scene that the participants shown in FIG. 5 experience from their perspective (e.g., a burning building, a bank heist, a castle).

A computer system may be included in the real environment (e.g., for operating the virtual studio). The computer system can include on-site or off-site components such as a remote server, or even a cloud-based server (e.g., control software could be run using Amazon Web Services). The computer system can be provided by one or more processors and memory and include the virtual display devices (e.g., a chip in a head-mounted display device). Other combinations are possible. The processing power offered by the computing system can determine via sensors the locations or actions of people and can maintain information representing a virtual scene that is presented to the participants.

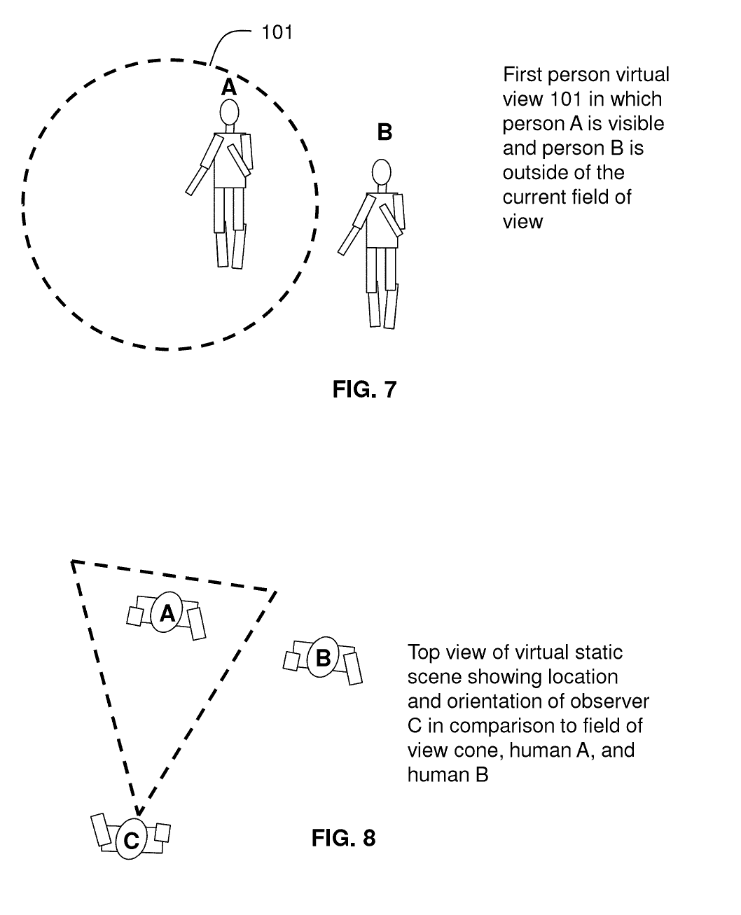

FIGS. 7 and 8 illustrate a virtual scene. FIG. 7 depicts the view as rendered by the system and seen by person C, while FIG. 8 gives a top-down view showing the locations of persons A, B, and C as maintained by the computing system. It can be understood that certain motions within the scene can create spatial-temporal conflict in the real world. A person walking in the scene will also be walking in the real world, changing the spatial-temporal relationships among real world participants and objects. This can give rise to spatial-temporal conflicts, which includes collisions but can also include spatial conflicts or safety hazards such as walking off of edges or proximity to unrealistic events such as walking into real-world earshot of conversations that are non-sequitur in the virtual environment. Systems and methods of the invention can be used to null the spatial-temporal conflicts.

Particular value in the invention may lie in methods and systems that can be used for simulating very hazardous environments to train personnel. Thus, systems and methods may be used by an organization (such as an armed service, a police force, a fire department, or an emergency medical corps) to include members of that organization in scenarios that serve organizationally-defined training objective. Since systems or methods of the invention may be used for training uniformed personnel by presenting a hazardous environment in a virtual setting, organizations may remove the risks and liabilities associated with exposing its recruits or members to real-world hazards and still gain the benefits associated with training those uniformed personnel. Examples of uniformed personnel include law-enforcement officers, firefighters, and soldiers. A hazardous environment may be defined as an environment that, in a non-virtual setting, poses a threat to human life that is recognized by any reasonable person upon being given a description of the environment. A raging fire in a building is a hazardous environment, as is any environment in which weapons are being used with intent to kill or maim humans or with wanton disregard to human safety.

The concept behind spatial-temporal nulling allows the immersive participant to focus on tasks while the underpinning algorithms handle and actively manage potential spatial conflicts without the participant being aware. Spatial-temporal nulling implicitly addresses conflicts without the introduction of distracting, unrealistic augmented notifications or symbols in the virtual scene.

In an immersive, multi-participant system implementing spatial-temporal nulling for spatial conflict control may address potential conflict on a person-by-person basis. Sensors in the physical space determine location, orientation, and velocity of participants. Any time a person is physically moving (standing stationary but turning their head, walking, rotating their body) virtual nulling can be employed. Benefits of spatial-temporal conflict nulling may be appreciated by representing a virtual scene overlaid on a real scene.

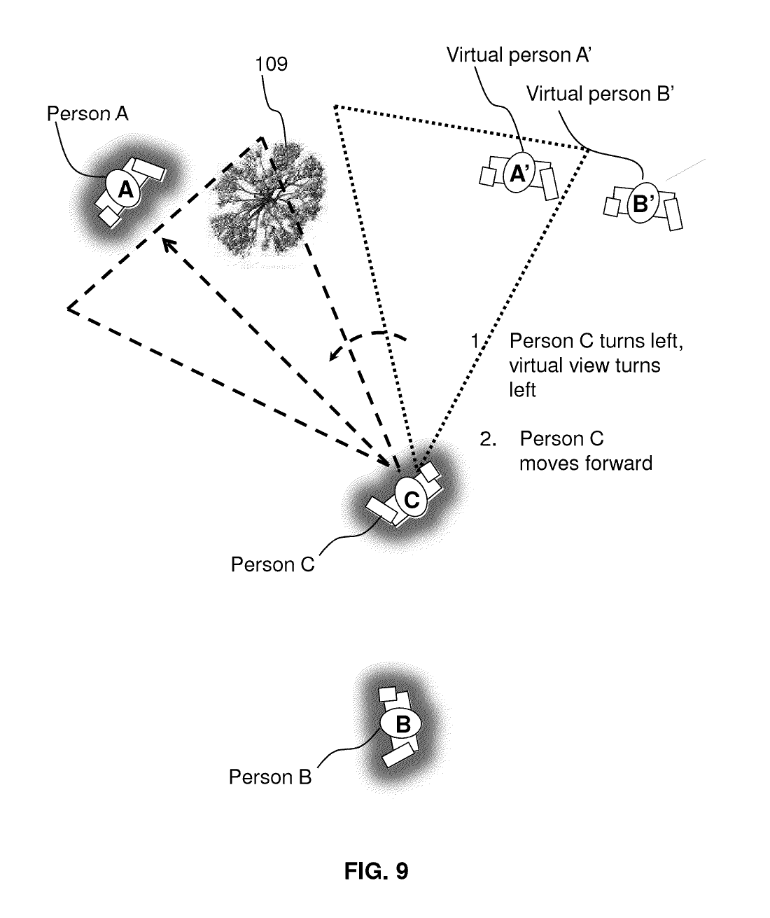

FIG. 9 represents a virtual scene overlaid on a real scene. Here, physical real world person C (physical persons are shown in diagrams with shadows) is walking towards real person A. Real person B is standing off to a side. However, real person C is able to see virtual person A′ off to their right, with virtual person B′ to the right of that. In the depicted scenario, person C first turns left, and the virtual reality computer system pans the scene (by panning the contents to the right) to create the perception to person C that person C's view has swept to the left with their turn to the left. Second, person C then moves forward for reasons related to the scenario and tasks depicted within the virtual environment. Unbeknownst to person C, they are now moving on a path associated with a probable collision with person A. Methods and systems of the invention avoid the collision.

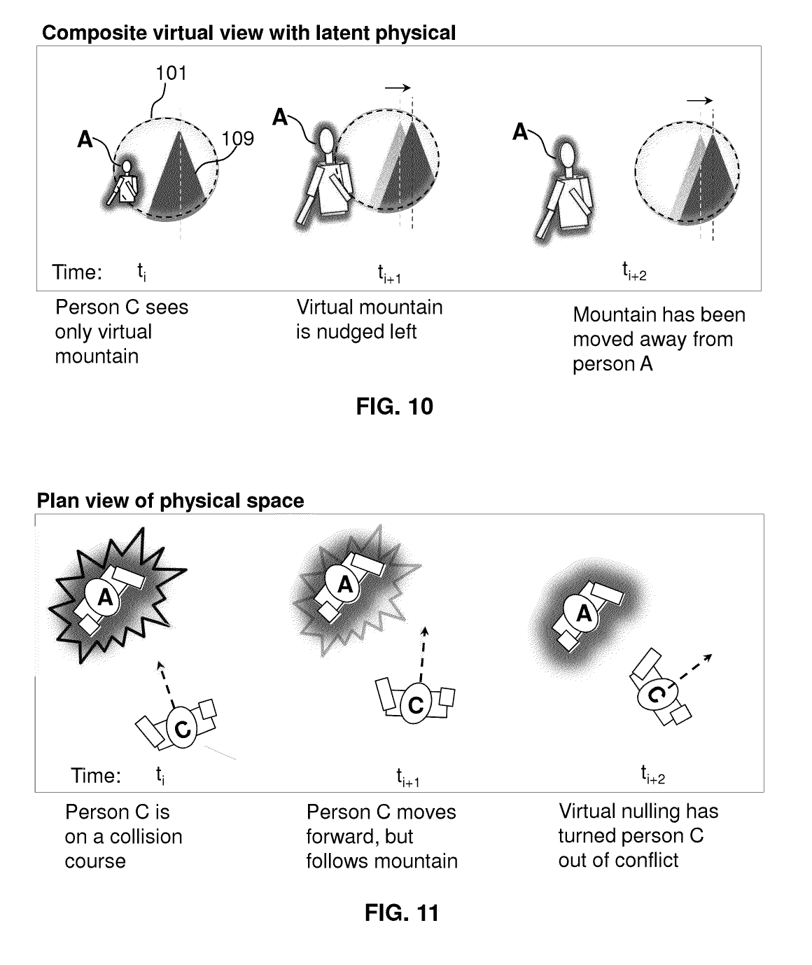

FIGS. 10 and 11 illustrate virtual nulling for collision avoidance. Spatial-temporal virtual scene nulling works by giving subtle “correction” cues to mitigate or remove the potential for spatial conflict. For example, in a 60 frame per second head mounted display, the system can slowly “drift” the “centerline” of a task (walking toward a tree, for example) to “lead” the participant off the physical path of spatial conflict. Controls in the implementation of the patent will allow configuration on the extent to which nulling occurs to mitigate problems with the implementation such as negatively affecting the human inner ear balance while nulling is occurring.

In FIG. 10, at time=ti, person C sees landmark 109 (a mountain) within virtual environment 101. Because person C is on a course associated with a probable collision with person A, as shown in FIG. 11, systems and methods of the invention will determine an adjustment to person C's motion that will nullify the collision. The system determines that shifting motion to the right would nullify the collision. At time=ti+1, the system is shifting landmark 109 towards the right. The system may shift all of the contents of virtual environment 101 around person C to accomplish this. Thus at time=ti+2, person C is still propelling themselves to their goal and has adjusted their physical motion to the right. As shown in FIG. 11, this means that the probable spatial conflict (collision) with person A has been nullified.

In some embodiments, the invention exploits the insight that visual input can persuade the human mind even in the face of contrary haptic or kinesthetic input. Thus, in the case of a human who sees an environment depicting the motion of that human as being in a straight line while that human is moving in a straight line, the human may perceive themselves to be moving in a straight line. Without being bound by any mechanism of action, it is theorized that the actual neurological perception accords with the visual input and the person may fully perceive themselves to be following the visual cues rather than the kinesthetic cues. The dominance of visual perception is discussed in U.S. Pub. 2011/0043537 to Dellon, the contents of which are incorporated by reference for all purposes.

Spatial-temporal virtual scene nulling can provide a foundation for not only mitigation of spatial conflict for human participants, but also to work around other physical props used in the scene (a fiberglass physical rock outcropping prop, for example) or physical room constraints (support pillars, for example).

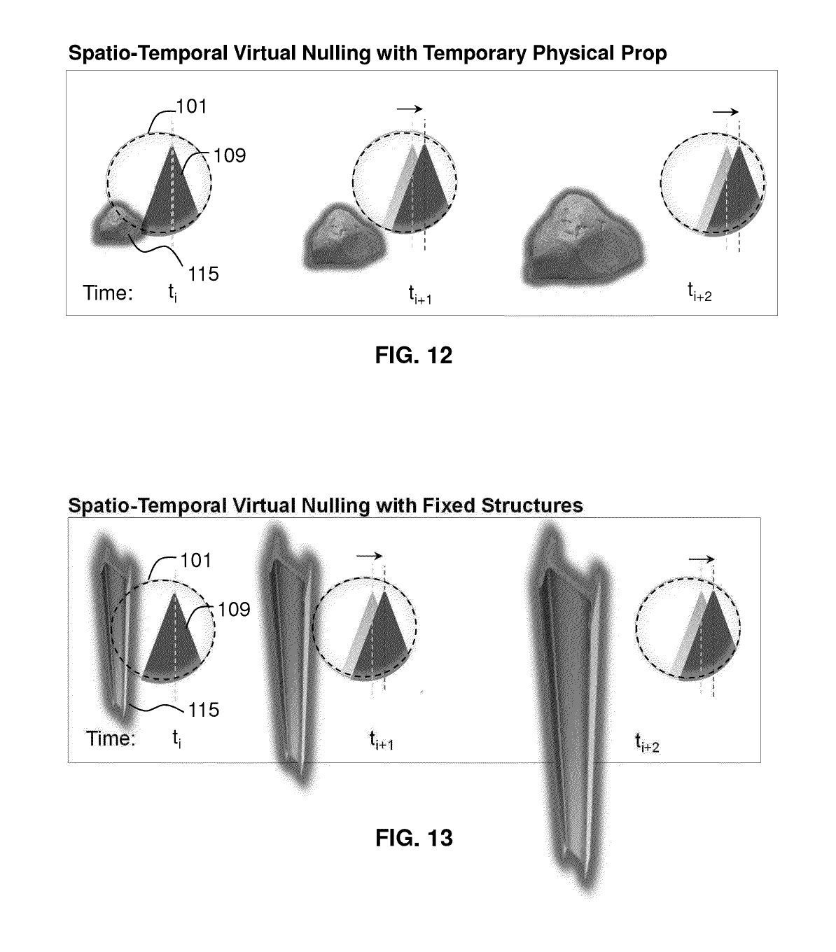

FIG. 12 reveals avoiding collision with a prop. Following the same logic and flow as depicted in FIGS. 10 and 11, it will be appreciated that systems and methods of the invention can be used to guide a person towards or away from a physical object. Here, in FIG. 12, prop 115 (e.g., a big rock) exists in the path of a person. A landmark 109 is shifted within virtual scene 101 to guide the person away from colliding with prop 115.

FIG. 13 includes a structural element 115 in a collision avoidance. The same basic logic is followed as in FIGS. 6 and 7. A location of prop 115 can be provided for the computer system by a sensor on prop 115 or by prior input and stored in memory.

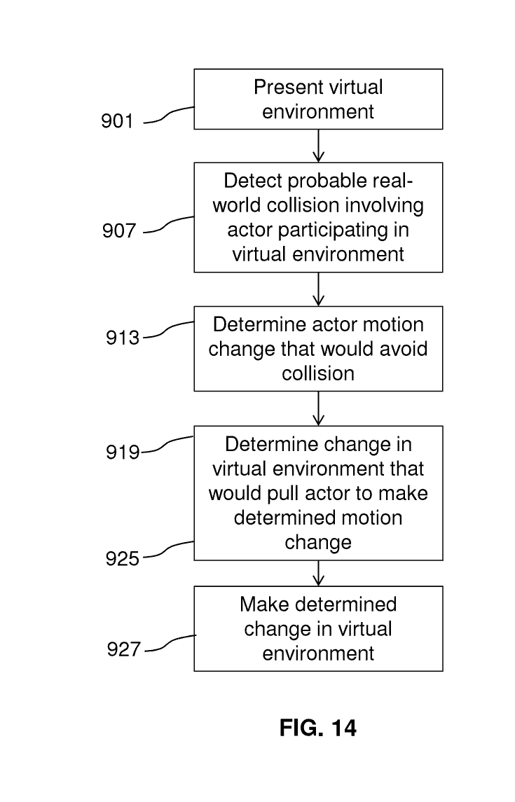

FIG. 14 diagrams methods of the invention. A virtual environment is presented 901 to a participant. A computer system is used to detect 907 a probable real-world collision involving the participant. The computer system is used to determine 913 a motion of the participant that would avoid the probable real-world collision. The computer system may then determine 919 a change in the virtual environment that would “pull” the participant in a certain direction, causing the participant to make the determined motion that would avoid the probable real-world collision. The computer system will then make 927 the determined change to the virtual environment.

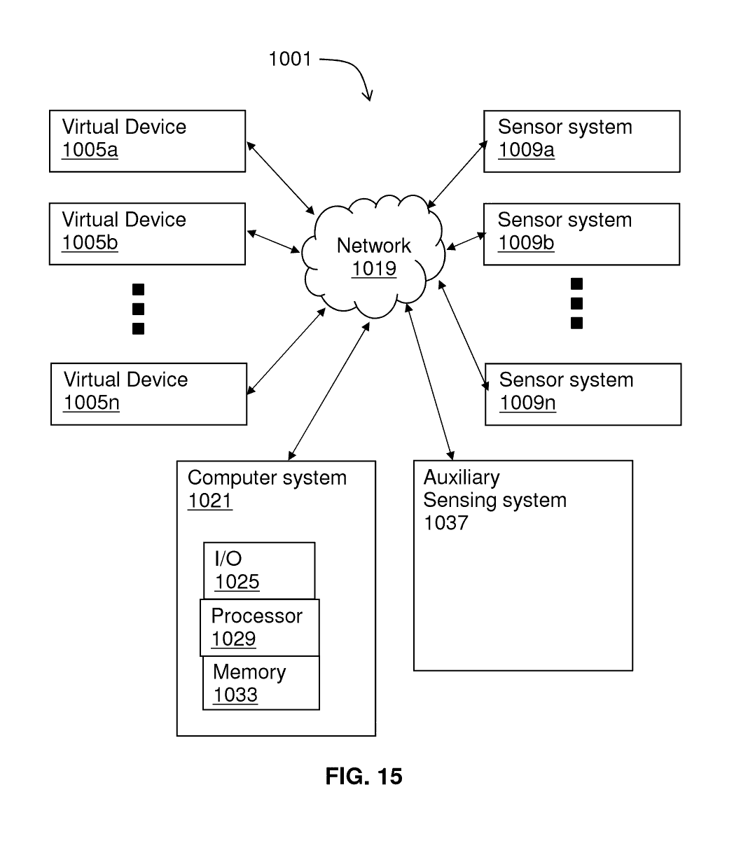

FIG. 15 presents a system 1001 for implementing methods described herein. System 1001 may include one or any number of virtual display device 1005n as well as one or any number of sensor system 1009n. Each virtual display device 1005 may be, for example, a head-mounted display, a heads up display in a vehicle, or a monitor. Each sensor system 1009 may include, for example, a GPS device or an accelerometer. These components may communicate with one another or with a computer system 1021 via a network 1019. Network 1019 may include the communication lines within a device (e.g., between chip and display within a head mounted display device), data communication hardware such as networking cables, Wi-Fi devices, cellular antenna, or a combination thereof. Computer system 1021 preferable includes input/output devices 1025 such as network interface cards, Wi-Fi cards, monitor, keyboard, mouse, touchscreen, or a combination thereof. Computer system 1021 may also include a processor 1029 coupled to memory 1033, which may include any combination of persistent or volatile memory devices such as disk drives, solid state drives, flash disks, RAM chips, etc. Memory 1033 preferably thus provides a tangible, non-transitory computer readable memory for storing instructions that can be executed by computer system 1021 to cause virtual environment system 1001 to perform steps of methods described herein.

Systems and methods for implementing virtual environments that may be modified for use with invention are described in U.S. Pub. 2004/0135744 to Bimber; U.S. Pat. No. 7,717,841 to Brendley; U.S. Pub. 2012/0249590 to Maciocci; U.S. Pub. 2012/0249741 to Maciocci; U.S. Pat. No. 8,414,130 to Pelah; U.S. Pub. 2010/0265171 to Pelah; and U.S. Pat. No. 7,073,129 to Robarts, the contents of each of which are incorporated by reference. Additional useful technical background may be found in U.S. Pat. No. 8,291,324 to Battat; U.S. Pat. No. 6,714,213 to Lithicum; U.S. Pat. No. 6,292,198 to Matsuda; U.S. Pat. No. 5,900,849 to Gallery; U.S. Pub. 2014/0104274 to Hilliges; or U.S. Pub. 2003/0117397 to Hubrecht, the contents of each of which are incorporated by reference.

As used herein, the word “or” means “and or or”, sometimes seen or referred to as “and/or”, unless indicated otherwise.

References and citations to other documents, such as patents, patent applications, patent publications, journals, books, papers, web contents, have been made throughout this disclosure. All such documents are hereby incorporated herein by reference in their entirety for all purposes.

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A collision avoidance method comprising:
exposing, using a computer system comprising a processor coupled to a non-tangible memory, a participant to a virtual environment;
detecting, using the processor, a motion of the participant associated with a probable collision;
determining, using the processor, a change to the motion that would nullify the probable collision; and
shifting an apparent position of an element of the virtual environment according to the determined change, thereby causing the participant to adjust the motion and nullify the probable collision.

2. The method of claim 1, wherein exposing the participant to the virtual environment comprises operating a head-mounted display being worn by the participant.

3. The method of claim 1, wherein detecting the motion is performed using a sensor on the participant and a second sensor on an item that is associated with the probable collision.

4. The method of claim 1, wherein detecting the motion associated with the probable collision comprises:
using a sensing system coupled to the computer system to measure a location and the motion of the participant;
using the sensing system to determine a location and motion of an item also associated with the probable collision;
modeling, using the computer system, a projected motion of the participant and a projected motion of the item and determining that the projected motion of the participant and the projected motion of the item come within a certain distance of one another, indicating the probable collision; and
associating the probable collision with the location and the motion of the participant.

5. The method of claim 1, wherein shifting the apparent position of the element of the virtual environment comprises using the processor for:
modeling the motion of the participant as a participant vector within a real space coordinate system;
modeling a location and motion of an item also associated with the probable collision as an item vector within the real space coordinate system;
describing the apparent position of the element of the virtual environment as an element vector within a virtual coordinate system;
determining a transformation of the participant vector that would nullify the probable condition; and
performing the transformation on the element vector within the virtual coordinate system.

6. The method of claim 1, wherein the virtual environment comprises a personnel training tool.

7. The method of claim 1, wherein the probable collision is associated with the participant and a second participant.

8. The method of claim 7, wherein the participant and the second participant are each depicted within the virtual environment, and further wherein a distance between the participant and the second participant is less than an apparent distance between the participant and the second participant within the virtual environment.

9. The method of claim 1, wherein the participant is a human.

10. The method of claim 1, wherein the participant is one selected from the list consisting of a robot, an unmanned vehicle, and an autonomous vehicle.

11. A collision-avoidance method comprising:
presenting a virtual environment to a person;
detecting a convergence between the person and a physical object;
determining a change in motion of the person that would void the convergence; and
changing the virtual environment to encourage the person to make the change in motion.

12. The method of claim 11, wherein changing the virtual environment comprises shifting an apparent position of an element within the virtual environment in a direction away from the physical object.

13. A virtual environment system with collision avoidance, the system comprising:
a virtual display device operable to expose an participant to a virtual environment;
a sensor operable to detect a motion of the participant; and
a computer system comprising a processor coupled to a tangible, non-transitory memory operable to
communicate with the sensor and the display device,
associate the motion with a probable collision,
determine a change to the motion that would nullify the probable collision, and
provide updated data for the virtual display device for shifting an apparent position of an element of the virtual environment according to the determined change, thereby causing the participant to adjust the motion and nullify the probable collision.

14. The system of claim 13, wherein the virtual display device is a head-mounted display unit.

15. The system of claim 13, further comprising a second sensor on an item that is associated with the probable collision.

16. The system of claim 13, wherein the system is operable to:
measure a location and the motion of the participant;
determine a location and motion of an item also associated with the probable collision; and
model a projected motion of the participant and a projected motion of the item and determine that the projected motion of the participant and the projected motion of the item come within a certain distance of one another, indicating the probable collision.

17. The system of claim 13, wherein the system is operable to:
model the motion of the participant as a participant vector within a real space coordinate system;
model a location and motion of an item also associated with the probable collision as an item vector within the real space coordinate system;
describe the apparent position of the element of the virtual environment as an element vector within a virtual coordinate system;
determine a transformation of the participant vector that would nullify the probable condition; and
perform the transformation on the element vector within the virtual coordinate system.

18. The system of claim 13, wherein the virtual environment depicts a hazardous environment for training personnel.

19. The system of claim 13, wherein the probable collision is associated with the participant and a second participant.

20. The system of claim 19, wherein the system is operable to depict the participant and the second participant within the virtual environment, and further wherein a distance between the participant and the second participant is less than an apparent distance between the participant and the second participant within the virtual environment.
